(19) United States
(12) Patent Application Publication
(10) Pub. No.: US 2026/0214327 A1
(43) Pub. Date: Jul. 23, 2026

(54) IMAGING SYSTEM

(71) Applicant: TOYOTA JIDOSHA KABUSHIKI KAISHA, Aichi-ken (JP)

(72) Inventor: Satoshi NAITO, Yokohama-shi (JP)

(21) Appl. No.: 19/450,722

(22) Filed: Jan. 16, 2026

(30) Foreign Application Priority Data
Jan. 23, 2025 (JP) 2025-009887

(51) Int. Cl. H04N 23/661; B60K 35/10; H04N 23/20; H04N 23/90

(52) U.S. Cl. CPC H04N 23/662; B60K 35/10; H04N 23/20; H04N 23/90; B60K 2360/21

(57) ABSTRACT

The imaging system includes a first camera module for performing infrared imaging by irradiating a predetermined first range with infrared light, a first control device for controlling the first camera module, and a second camera module which is connected to the first camera module via a communication line, and which is for performing infrared imaging by irradiating a predetermined second range, at least a part of which overlaps the first range, with infrared light. The first camera module, in response to an infrared imaging instruction from the first control device, starts infrared imaging and transmits an infrared imaging instruction to the second camera module via the communication line after a predetermined offset time has elapsed from start of the infrared imaging. The second camera module, in response to the infrared imaging instruction from the first camera module, starts infrared imaging.

### FIELD

The present disclosure relates to an imaging system.

### BACKGROUND

Patent Literature 1 discloses that as a conventional imaging system, by performing vehicle-to-vehicle communication between imaging control devices of each of the vehicles, which each comprise a camera module for generating an infrared image, the timing of infrared light irradiation by the camera modules of each of the vehicles can be controlled such that the quality of the infrared images captured by the camera module of one vehicle does not deteriorate due to the influence of infrared light irradiated from the camera module of another vehicle.

### CITATION LIST

### Patent Literature

[PTL 1] Japanese U.S. Pat. No. 6,743,708

### SUMMARY

### Technical Problem

In the conventional imaging system described above, to properly control the infrared light emission timing of each of the camera modules, which have overlapping capture ranges, it is necessary to synchronize the times between the imaging control devices for controlling the camera modules. However, because it is not easy to achieve high-precision time synchronization between imaging control devices, there is a risk that the infrared light emission timing of each camera module will deviate from the appropriate timing.

The present disclosure was conceived in response to this problem, and an object thereof is to prevent the infrared light emission timing of each of the camera modules, which have overlapping capture ranges, from deviating an appropriate timing.

### Solution to Problem

In order to solve the above problem, the imaging system according to one aspect of the present disclosure includes a first camera module for performing infrared imaging by irradiating a predetermined first range with infrared light, a first control device for controlling the first camera module, and a second camera module which is connected to the first camera module via a communication line, and which is for performing infrared imaging by irradiating a predetermined second range, at least a part of which overlaps the first range, with infrared light. The first camera module, in response to an infrared imaging instruction from the first control device, starts infrared imaging and transmits an infrared imaging instruction to the second camera module via the communication line after a predetermined offset time has elapsed from start of the infrared imaging. The second camera module, in response to the infrared imaging instruction from the first camera module, starts infrared imaging.

Further, the imaging system according to another aspect of the present disclosure includes a first camera module for performing infrared imaging by irradiating a predetermined first range with infrared light, a first control device for controlling the first camera module, and a second camera module which is connected to the first camera module via a communication line, and which is for performing infrared imaging by irradiating a predetermined second range, at least a part of which overlaps the first range, with infrared light. The first camera module, in response to an infrared imaging instruction from the first control device, starts infrared imaging and transmits an infrared imaging instruction to the second camera module via the communication line. The second camera module starts infrared imaging after a predetermined offset time has elapsed since receiving the infrared imaging instruction from the first camera module.

According to these aspects of the present disclosure, it is possible to prevent the infrared light emission timing of each of the camera modules, which have overlapping capture ranges, from deviating an appropriate timing.

### BRIEF DESCRIPTION OF DRAWINGS

FIG. 1 is a schematic view of an imaging system according to a first embodiment of the present disclosure.

FIG. 2 is a schematic system configuration view of the imaging system according to the first embodiment of the present disclosure.

FIG. 3 is a time chart showing capture timing of each infrared camera module of the imaging system according to the first embodiment of the present disclosure.

FIG. 4 is a schematic system configuration view of an imaging system according to a second embodiment of the present disclosure.

### DESCRIPTION OF EMBODIMENTS

Hereinafter, embodiments of the present disclosure will be described in detail with reference to the drawings. In the following description, the same reference numerals are given to the same constituent elements.

### First Embodiment

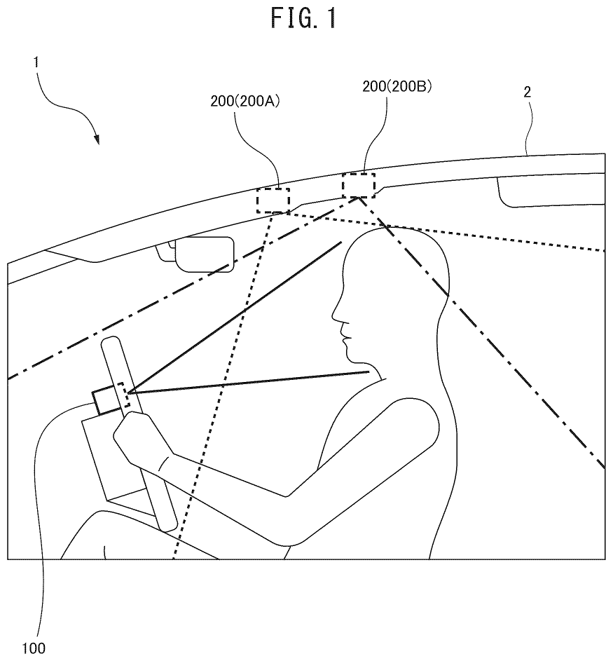

FIG. 1 is a schematic view of an imaging system 1 according to a first embodiment of the present disclosure.

The imaging system 1 is a system for capturing an area within a monitoring range using a plurality of infrared camera modules, the capture ranges of which at least partially overlap.

As shown in FIG. 1, the imaging system 1 according to the present embodiment is configured to capture the interior of a vehicle 2 (hereinafter referred to as the “vehicle interior”), and includes an infrared camera module 100 which functions as a master device and two infrared camera modules 200 which function as slave devices. In the following description, when it is necessary to specifically distinguish between the two infrared camera modules 200 functioning as slave devices, they will be referred to individually as the infrared camera module 200A and the infrared camera module 200B.

The infrared camera module 100 captures the face of the driver in the vehicle interior for the primary purpose of detecting facial orientation, line of sight, and the open/closed state of the eyes of the driver of the vehicle 2, and in the present embodiment, is installed on the top surface of the steering column.

The infrared camera module 200A captures each seat in the vehicle interior from above for the primary purpose of detecting whether the seatbelts of the vehicle occupants seated in each seat of the vehicle 2 are fastened or unfastened, and in the present embodiment, is installed on the ceiling of the vehicle interior.

The infrared camera module 200B captures the front seats in the vehicle interior from above, for the primary purpose of detecting manual operations (for example, smartphone operations, navigation device operations, pointing operations, etc.) made by vehicle occupants (driver and passenger seat occupant) seated in the front seats of the vehicle 2, and in the present embodiment, is installed on the ceiling in the vehicle interior.

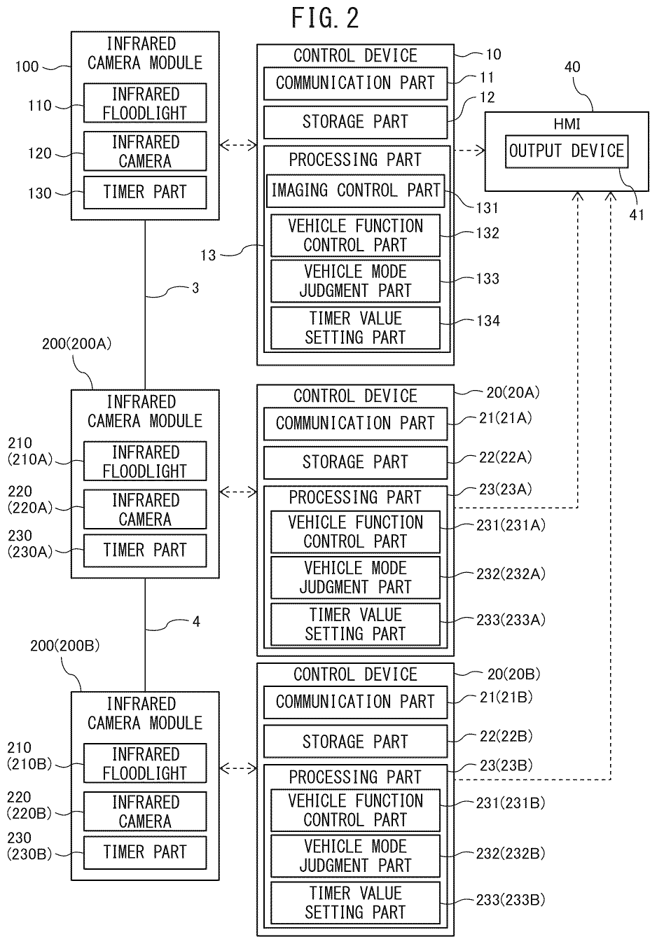

When the capture ranges of each of the infrared camera modules 100, 200A, 200B are defined as a first capture range, a second capture range, and a third capture range, respectively, all of the capture ranges essentially include the face of the driver. Specifically, at least a part of the first capture range overlaps the second capture range and the third capture range, at least a part of the second capture range overlaps the first capture range and the third capture range, and at least a part of the third capture range overlaps the first capture range and the second capture range. Thus, if the capture timing of each of the infrared camera modules 100, 200A, 200B is not appropriately controlled, the infrared light emitted from one of the infrared camera modules 100, 200A, 200B may affect the quality of the infrared images captured by the other infrared camera modules, resulting in degradation of image quality (for example, halation or the formation of unnecessary shadows). Thus, in the present embodiment, the infrared camera modules 100, 200A, 200B are daisy-chain connected to appropriately control the capture timing, as will be described in detail below with reference to FIG. 2.

FIG. 2 is a schematic system configuration view of the imaging system 1.

In addition to the infrared camera modules 100, 200, the imaging system 1 includes a control device 10 for controlling the infrared camera module 100 and a control device 20 for controlling the infrared camera module 200. In the following description, as necessary, the control device 20 for controlling the infrared camera module 200A will be referred to as control device 20A, and the control device 20 for controlling the infrared camera module 200B will be referred to as control device 20B.

The infrared camera modules 100, 200A, 200B are connected in series in order by communication lines 3 and 4, with the infrared camera module 100 serving as the master device at the head, and the infrared camera modules 200A, 200B serving as slave devices. Specifically, the infrared camera modules 100, 200A, 200B are daisy-chain connected.

The configuration of the infrared camera module 100 functioning as the master device and the control device 10 therefor will be described below.

The infrared camera module 100 includes an infrared floodlight 110, an infrared camera 120, and a timer part 130.

The infrared floodlight 110 includes an infrared light-emitting diode for emitting infrared light, and irradiates a capture range of the infrared camera 120 with infrared light of a predetermined wavelength IR1 [nm] in response to a capture instruction signal from the control device 10 (which will be described later). IR1 [nm] is, for example, 850 [nm] or 940 [nm].

In response to the capture instruction signal from the control device 10, the infrared camera 120 executes infrared imaging by selectively receiving, using an optical filter or the like, the infrared light of wavelength IR1 irradiated from the infrared floodlight 110 and reflected by the subject. The infrared camera 120 transmits the infrared image generated by the infrared imaging to the control device 10.

The timer part 130 is, for example, a digital circuit for delaying signals by means of a timer. When the timer part 130 receives the capture instruction signal from the control device 10, it transmits the capture instruction signal to the infrared camera module 200A daisy-chain connected to the infrared camera module 100 via the communication line 3 at a timing delayed by a predetermined timer value from the timing at which the capture instruction signal was received.

The control device 10 is an electronic control unit (ECU) including a communication part 11, a storage part 12, and a processing part 13.

The communication part 11 includes an interface circuit for connecting the control device 10 to the infrared camera module 100, a human machine interface (HMI) 40 (which will be described later), etc. The communication part 11 supplies data received from the outside, such as the infrared images received from the infrared camera 120, to the processing part 13. The communication part 11 also transmits output signals output from the processing part 13 to the outside, such as transmitting the capture instruction signal output from the processing part 13 to the infrared camera module 100.

The storage part 12 includes a storage medium such as a hard disk drive (HDD), a solid state drive (SSD), or a semiconductor memory, and stores various computer programs and data used in processing by the processing part 13.

The processing part 13 includes one or more central processing units (CPUs) and peripheral circuits therefor, and executes the various computer programs stored in the storage part 12. The processing part 13 is, for example, a processor. By executing processing in accordance with the computer programs, the processing part 13 functions as an imaging control part 131, a vehicle function control part 132, a vehicle mode judgment part 133, and a timer value setting part 134, and operates as functional parts (modules) for realizing predetermined functions. In the following description, processing described using each of the functional parts 131 to 134 as the subject indicates that the processing part 13 is executing a program for realizing each of the functional parts 131 to 134.

The imaging control part 131 controls the infrared camera module 100. The imaging control part 131 transmits a capture instruction signal to the infrared camera module 100 at a predetermined capture period ΔT (for example, several tens to several hundreds of ms). The capture instruction signal includes an infrared light emission instruction to the infrared floodlight 110 and an exposure instruction to the infrared camera 120. The infrared light emission instruction to the infrared floodlight 110 can include information related to the irradiation time of the infrared light, as needed. The exposure instruction to the infrared camera 120 can include information related to the light reception time (exposure time), as needed.

In the present embodiment, since the capture instruction signal transmitted from the imaging control part 131 to the infrared camera module 100, which is the master device, is ultimately transmitted sequentially to each of the slave devices (infrared camera modules 200A, 200B), the imaging control part 131 also substantially controls each of the infrared camera modules 200, which are slave devices.

The vehicle function control part 132 receives a first infrared image generated by the infrared camera 120, and specifically, the first infrared image capturing the face of the driver, and controls the functions of the vehicle 2 based on the received first infrared image.

In the present embodiment, the vehicle function control part 132 analyzes the first infrared image in which the face of the driver is captured to detect the facial orientation, line of sight, and eye opening/closing state of the driver to detect whether the driver is looking away or dozing, and controls the HMI 40 of the vehicle 2 in accordance with the detection results. The HMI 40 is a user interface for exchanging information between the vehicle 2 and the occupants thereof, and includes at least output device 41 for notifying the vehicle occupant via bodily senses (for example, sight, hearing, touch, etc.) of the vehicle occupants. The output device 41 is, for example, a display (for example, a meter display, a center display, a head-up display, etc.), a speaker, a vibration device, etc. For example, when the vehicle function control part 132 detects that the driver is looking away or dozing, it issues a warning to the vehicle occupant via the output device 41 of the HMI 40.

The vehicle mode judgment part 133 judges the mode of the power switch of the vehicle 2. In the present embodiment, there are three modes of the power switch of the vehicle including an OFF mode, an ACC (accessory) mode, and an ON mode. The OFF mode is a mode in which the functions of the vehicle 2 are stopped and the vehicle 2 is in a stopped state. The ACC mode is a mode in which the vehicle 2 is not assumed to be running, and though power is supplied to some electrical components, the vehicle 2 itself cannot be run. The ON mode is a mode in which power is supplied to all electrical components, enabling the vehicle 2 to run.

In the present embodiment, when the mode of the power switch of the vehicle 2 is switched from the OFF mode or the ACC mode to the ON mode, infrared imaging by each of the infrared camera modules 100, 200 of the imaging system 1 is started. When the mode of the power switch of the vehicle 2 is then switched from the ON mode to the ACC mode or the OFF mode, infrared imaging by each of the infrared camera modules 100, 200 is stopped.

The timer value setting part 134 sets the timer value of the timer part 130. In the present embodiment, when the vehicle 2 is started, and specifically, when the mode of the power switch of the vehicle 2 is switched from the OFF mode to the ACC mode or the ON mode, the timer value setting part 134 sets the timer value of the timer part 130 to a predetermined first offset time T1 [ms].

Next, the configuration of the infrared camera module 200 functioning as a slave device and the control device 20 therefor will be described.

The infrared camera module 200 includes an infrared floodlight 210, an infrared camera 220, and a timer part 230.

The configuration of the infrared floodlight 210 is the same as that of the infrared floodlight 110 of the master device. However, the infrared floodlight 210 of the slave device responds to capture instruction signals transmitted sequentially from the infrared camera module of the daisy-chain connected master device, rather than from the control device 20, and irradiates the capture range of the infrared camera 220 with infrared light of the predetermined wavelength IR1 [nm].

Specifically, the infrared floodlight 210A of the infrared camera module 200A irradiates the capture range of the infrared camera 220A with infrared light in response to a capture instruction signal transmitted via the timer part 130 of the infrared camera module 100 with a delay of the timer value (first offset time T1) of the timer part 130 after the infrared camera module 100 receives the capture instruction signal from the control device 10. The infrared floodlight 210B of the infrared camera module 200B irradiates the capture range of the infrared camera 220B with infrared light in response to a capture instruction signal transmitted via the timer part 230A of the infrared camera module 200A with a delay of the timer value (second offset time T2, which will be described later) of the timer part 230A after the infrared camera module 200A receives the capture instruction signal from the infrared camera module 100.

The configuration of the infrared camera 220 is the same as that of the infrared camera 220 of the master device. However, the infrared camera 220 of the slave device performs infrared imaging in response to a capture instruction signal transmitted sequentially from the infrared camera module of the daisy-chain connected master device, rather than from the control device 20.

Specifically, the infrared camera 220A of the infrared camera module 200A performs infrared imaging in response to a capture instruction signal transmitted via the timer part 130 of the infrared camera module 100 with a delay of the timer value (first offset time T1) of the timer part 130 after the infrared camera module 100 receives the capture instruction signal from the control device 10. The infrared camera 220B of the infrared camera module 200B performs infrared imaging in response to a capture instruction signal transmitted via the timer part 230A of the infrared camera module 200A with a delay of the timer value (second offset time T2, which will be described later) of the timer part 230A after the infrared camera module 200A receives the capture instruction signal from the infrared camera module 100.

The configuration of the timer part 230 is the same as the configuration of the timer part 130 of the master device. However, the timer part 230 of the slave device receives the capture instruction signal from the master device or a slave device, on the master device side, that is daisy-chain connected with the infrared camera module 200, rather than from the control device 20. When the timer part 230 receives the capture instruction signal from the master device or a slave device on the master device side, if there is another slave device daisy-chain connected with the infrared camera module 200, the timer part 230 transmits the capture instruction signal to that slave device at a timing delayed by a predetermined timer value from the timing at which the capture instruction signal was received.

Specifically, the timer part 230A of the infrared camera module 200A receives a capture instruction signal from the infrared camera module 100, which is the master device daisy-chain connected to the infrared camera module 200A, and transmits the capture instruction signal to the infrared camera module 200B, which is a slave device daisy-chain connected to the infrared camera module 200A, at a timing delayed by a predetermined timer value from the timing at which the capture instruction signal is received. In the present embodiment, since there are no slave devices daisy-chain connected to the infrared camera module 200B, the timer part 230B of the infrared camera module 200B is inactive.

The control device 20 is an electronic control unit (ECU) including a communication part 21, a storage part 22, and a processing part 23.

The communication part 21 includes an interface circuit for connecting the control device 20 to the infrared camera module 100, the HMI 40, etc. The communication part 21 supplies data received from the outside, such as infrared images received from the infrared camera 220, to the processing part 23. The communication part 21 also transmits output signals output from the processing part 23 to the outside.

The storage part 22 includes a storage medium such as a hard disk drive (HDD), a solid state drive (SSD), or a semiconductor memory, and stores various computer programs and data used in processing by the processing part 23.

The processing part 23 includes one or more central processing units (CPUs) and peripheral circuits therefor, and executes the various computer programs stored in the storage part 22. The processing part 23 is, for example, a processor. By executing processing in accordance with the computer programs, the processing part 23 functions as a vehicle function control part 231, a vehicle mode judgment part 232, and a timer value setting part 233, and operates as functional parts (modules) for realizing predetermined functions. In the following description, processing described using each of the functional parts 231 to 233 as the subject indicates that the processing part 23 is executing a program for realizing each of the functional parts 231 to 233.

The vehicle function control part 231 receives the infrared images generated by the infrared camera 220 and controls the functions of the vehicle 2 based on the received infrared images.

In the present embodiment, the vehicle function control part 231A of the control device 20A detects whether the seatbelts of the vehicle occupants are fastened or unfastened by analyzing a second infrared image generated by the infrared camera 220A, and specifically, the second infrared image in which the vehicle occupants seated in the seats of the vehicle 2 are captured from above, and controls the HMI 40 of the vehicle 2 in accordance with the detection result. For example, when the vehicle function control part 231A detects the presence of a vehicle occupant for whom his or her seatbelt is not fastened, it issues a warning to the vehicle occupant via the output device 41 of the HMI 40.

The vehicle function control part 231B of the control device 20B detects manual operations performed by the vehicle occupants seated in the front seats (the driver's seat and the passenger seat) of the vehicle 2 by analyzing a third infrared image generated by the infrared camera 220B, and specifically, the third infrared image in which the vehicle occupants seated in the front seats are captured from above, and controls the HMI 40 of the vehicle 2 based on the detection results. For example, the vehicle function control part 231B detects a store or the like located in the direction the vehicle occupant is pointing from the manual operations performed by the vehicle occupant, and notifies the vehicle occupant of information about the store or the like via the output device 41 of the HMI 40.

The vehicle mode judgment part 232 judges the mode of the power switch of the vehicle 2 in the same manner as the vehicle mode judgment part 133 of the master device.

In the same manner as the timer value setting part 134 of the master device, the timer value setting part 233 sets the timer value of the timer part 230 to a predetermined second offset time T2 [ms] when the vehicle 2 is started, and specifically, when the mode of the power switch of the vehicle 2 is switched from the OFF mode to the ACC mode or the ON mode. In the present embodiment, the first offset time T1 and the second offset time T2 are the same time.

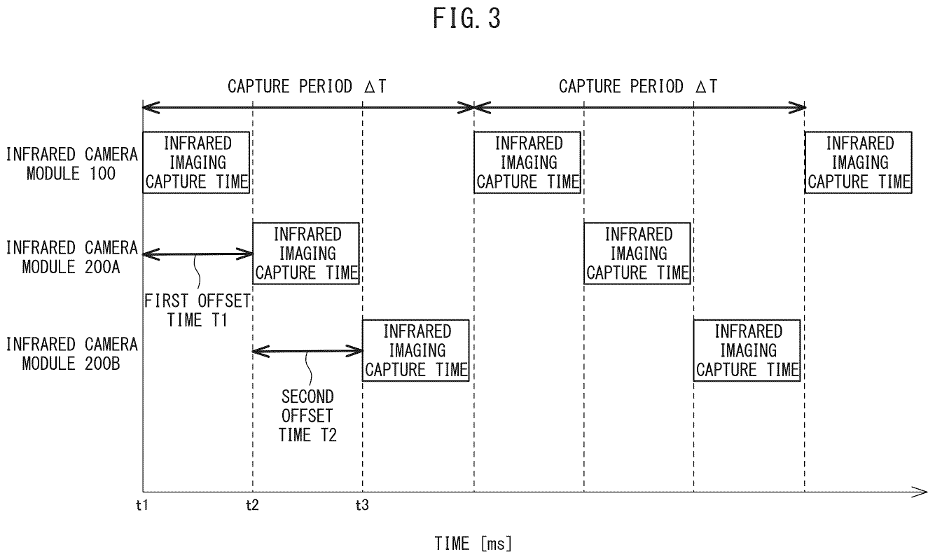

FIG. 3 is a timing chart showing capture timings of the infrared camera modules 100, 200A, 200B of the imaging system 1.

At time t1, when the infrared camera module 100, which is the master device, receives a capture instruction signal from the control device 10, emission of infrared light by the infrared floodlight 110 and exposure by the infrared camera 120 start, and the infrared camera module 100 performs infrared imaging.

The capture instruction signal received by the infrared camera module 100 from the control device 10 is then transmitted via the timer part 130 of the infrared camera module 100 to the infrared camera module 200A, which is a slave device daisy-chain connected with the infrared camera module 100, at time t2, which is delayed from time t1 by the timer value (first offset time T1) of the timer part 130. As a result, at time t2, emission of infrared light by the infrared floodlight 210A and exposure by the infrared camera 220A start, and the infrared camera module 200A performs infrared imaging.

The capture instruction signal received by the infrared camera module 200A from the infrared camera module 100 is then transmitted via the timer part 230A of the infrared camera module 200A to the infrared camera module 200B, which is a slave device daisy-chain connected to the infrared camera module 200A, at time t3, which is delayed from time t2 by the timer value (second offset time T2) of the timer part 230A. As a result, at time t3, emission of infrared light by the infrared floodlight 210B and exposure by the infrared camera 220B start, and the infrared camera module 200B performs infrared imaging.

In this manner, in the present embodiment, when the time during which infrared light is emitted by the infrared floodlight and exposure is performed by the infrared camera is referred to as the “capture time” of the infrared imaging by the infrared camera module, the first offset time T1 is set to a time which is longer than the capture time of the infrared camera module 100, and the second offset time T2 is set to a time which is longer than the capture time of the infrared camera module 200A such that the capture times of the infrared camera modules 100, 200A, 200B do not overlap.

Specifically, the first offset time T1 (timer value) of the timer part 130 of the infrared camera module 100 is set to a time when the timing at which infrared light is emitted from the infrared floodlight 210A of the infrared camera module 200A daisy-chain connected with the infrared camera module 100 comes after the timing at which the period (exposure period) during which the reflected light of the infrared light irradiated from the infrared floodlight 110 of the infrared camera module 100 is received by the infrared camera 120 of the infrared camera module 100 ends.

Likewise, the offset time T1 (timer value) of the timer part 230A of the infrared camera module 200A is set to a time when the timing at which infrared light is emitted from the infrared floodlight 210B of the infrared camera module 200B daisy-chain connected with the infrared camera module 200A comes after the end of the period (exposure period) in which the reflected light of the infrared light emitted from the infrared floodlight 210A of the infrared camera module 200A is received by the infrared camera 220A of the infrared camera module 200A.

As a result, the infrared light emitted from the infrared floodlight 210A of the infrared camera module 200A can be prevented from interfering with the infrared image captured by the infrared camera 120 of the infrared camera module 100, thereby degrading the infrared image. Likewise, the infrared light emitted from the infrared floodlight 210B of the infrared camera module 200B can be prevented from interfering with the infrared image captured by the infrared camera 220A of the infrared camera module 200A, thereby degrading the infrared image.

The imaging system 1 according to the present embodiment described above includes an infrared camera module 100 (first camera module) for performing infrared imaging by irradiating a predetermined first range with infrared light, a control device 10 (first control device) for controlling the infrared camera module 100, and an infrared camera module 200A (second camera module) which is daisy-chain connected with the infrared camera module 100 via a communication line 3, and which is for performing infrared imaging by irradiating a predetermined second range, at least a part of which overlaps with the first range with infrared light. The infrared camera module 100 is configured to start infrared imaging in response to a capture instruction signal (infrared imaging instruction) from the control device 10, and to transmit the capture instruction signal to the infrared camera module 200A via the communication line 3 after a predetermined offset time T1 has elapsed since the start of the infrared imaging, and the infrared camera module 200A is configured to start infrared imaging in response to the capture instruction signal from the infrared camera module 100.

Since the capture timing between each infrared camera module can be controlled by issuing an infrared imaging instruction from the infrared camera module 100, which is the master device, to the infrared camera module 200A, which is a slave device, in this manner, there is no need to synchronize the time between control devices 10, 20A, and the capture timings of the infrared camera modules (irradiation of infrared light by the infrared floodlight and exposure by the infrared camera) can be prevented from deviating from the appropriate timings.

In particular, in the present embodiment, the offset time T1 is set to a time when the timing at which infrared light is irradiated from the infrared camera module 200A for infrared imaging comes after the timing at which the exposure period during which the reflected light of the infrared light irradiated from the infrared camera module 100 for infrared imaging is received by the infrared camera module 100 ends.

Thus, the infrared light emitted from the infrared camera module 200A can be prevented from interfering with the first infrared image captured by the infrared camera module 100, thereby degrading the first infrared image.

Furthermore, in the imaging system 1 according to the present embodiment, the first infrared image generated by the infrared imaging of the infrared camera module 100 (first camera module) is an infrared image having a higher acquisition priority than the second infrared image generated by the infrared imaging of the infrared camera module 200A (second camera module). This is for the following reasons.

Specifically, in the present embodiment, if the infrared camera module 100 fails, neither the infrared camera module 100 nor the infrared camera module 200A can perform capture, since a capture instruction signal (infrared imaging instruction) is output from the infrared camera module 100 to the infrared camera module 200A. Conversely, if only the infrared camera module 200A fails, capture by the infrared camera module 100 is possible. Thus, by generating images with high acquisition priority by infrared imaging of the infrared camera module 100, even if the infrared camera module 200A fails, it is possible to continue generating images with high acquisition priority. Thus, according to the present embodiment, it is possible to prevent images with high acquisition priority from being unable to be generated.

For example, in the imaging system 1 according to the present embodiment, the infrared camera module 100 and the infrared camera module 200A are mounted in the vehicle 2, and the first infrared image is used to provide safe driving support (warning for dozing or looking away) for the vehicle 2, and the second infrared image is used for a purpose different from safe driving support for the vehicle 2 (warning for fastening or unfastening seatbelts). Thus, it is possible to prevent images used to provide driving support related to the safety of the driver or passengers from being unable to be generated.

Furthermore, the imaging system 1 according to the present embodiment further includes an infrared camera module 200B (third camera module) which is daisy-chain connected with the infrared camera module 200A (second camera module) via a communication line 4 (second communication line), and which is for performing infrared imaging by irradiating a predetermined third range, at least a part of which overlaps the first range and the second range, with infrared light. The infrared camera module 200A is configured to start infrared imaging in response to an infrared imaging instruction from the infrared camera module 100, and to transmit an infrared imaging instruction to the infrared camera module 200B via the communication line 4 after a predetermined second offset time T2 has elapsed since the start of the infrared imaging, and the infrared camera module 200B is configured to start infrared imaging in response to the infrared imaging instruction from the infrared camera module 200A.

As a result, the capture timings between the three or more infrared camera modules can appropriately be controlled, preventing the capture timing of each infrared camera module from deviating from the appropriate timing.

Furthermore, in the imaging system 1 according to the present embodiment, the second infrared image generated by infrared imaging of the infrared camera module 200A (second camera module) is an infrared image having a higher acquisition priority than the third infrared image generated by infrared imaging of the infrared camera module 200B (third camera module). As a result, even if the infrared camera module 200B fails, it is possible to continue generating the second infrared image in the infrared camera module 200A, which has a higher acquisition priority, and it is possible to prevent images having a high acquisition priority from being unable to be generated.

Furthermore, in the imaging system 1 according to the present embodiment, as described above, when the mode of the power switch of the vehicle 2 is switched from the OFF mode or the ACC mode to the ON mode, the infrared imaging by each of the infrared camera modules 100, 200 of the imaging system 1 is started, and when the mode of the power switch of the vehicle 2 is the switched from the ON mode to the ACC mode or the OFF mode, the infrared imaging by each of the infrared camera modules 100, 200 is stopped. In the manner of the present embodiment, a capture instruction signal is transmitted from the master device to the slave devices. Thus, if slight time errors occur in communication between the infrared camera modules over a long capture period, the time errors may accumulate, causing the capture timing of each infrared camera module to deviate from the appropriate timing. However, according to the present embodiment, infrared imaging by each of the infrared camera modules 100, 200 can be stopped at a timing specific to the vehicle, and the accumulation of time errors can be canceled at that timing.

Furthermore, according to the present embodiment, even if the wavelengths of the infrared light used in infrared imaging by each of the infrared camera modules 100, 200A, 200B are all the same wavelength IR1, and specifically, even if the same infrared floodlight is used for all of them, degradation of the infrared images does not occur, whereby cost can be reduced via mass production effects.

### Second Embodiment

Next, a second embodiment of the present disclosure will be described. The present embodiment differs from the first embodiment in that, instead of receiving a capture instruction signal and then delaying a predetermined timer value before transmitting the capture instruction signal to the slave devices, the slave devices receive the capture instruction signal and then delay infrared imaging by a predetermined timer value. The following description will focus on this difference.

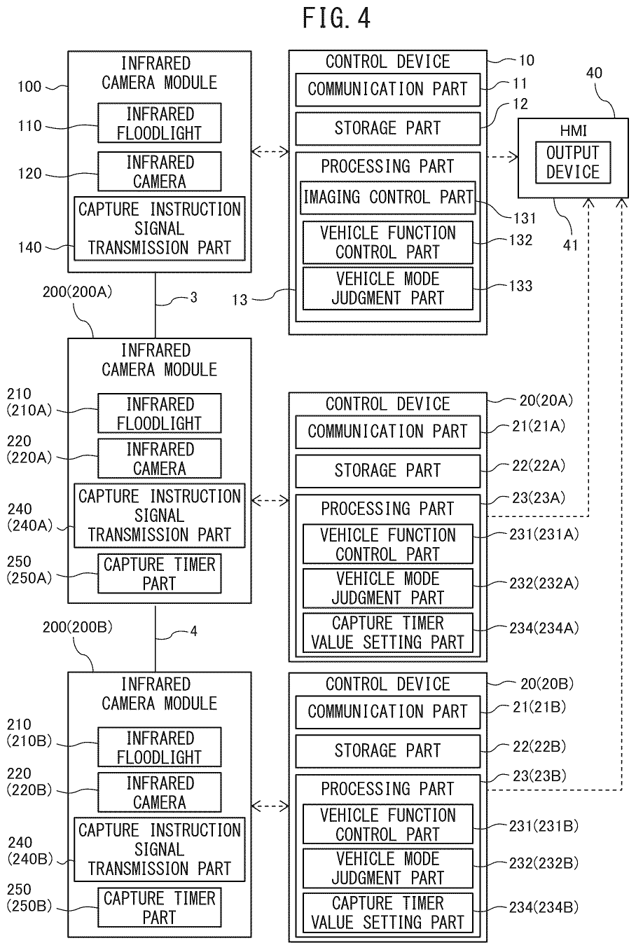

FIG. 4 is a schematic system configuration view of an imaging system 1 according to a second embodiment of the present disclosure.

In the present embodiment, the infrared camera module 100, which is the master device, includes a capture instruction signal transmission part 140.

When the capture instruction signal transmission part 140 receives a capture instruction signal from the control device 10, it transmits the capture instruction signal to the infrared camera module 200A daisy-chain connected with the infrared camera module 100 at the timing of receiving the capture instruction signal.

The infrared camera module 200, which is a slave device, includes a capture instruction signal transmission part 240 and a capture timer part 250.

When the capture instruction signal transmission part 240 receives a capture instruction signal from the infrared camera module of the daisy-chain connected master device or the infrared camera module on the master device side, if there is another slave device daisy-chain connected with the infrared camera module 200, it transmits the capture instruction signal to that slave device at the time it receives the capture instruction signal.

The capture timer part 250 is, for example, a digital circuit for delaying signals by means of a timer. When the capture timer part 250 receives a capture instruction signal from a daisy-chain connected master device or slave device on the master device side, it transmits the capture instruction signal to the infrared floodlight 210 and the infrared camera 220 at a timing delayed by a predetermined timer value from the timing at which the capture instruction signal was received.

The processing part 23 of the control device 20 of the infrared camera module 200 includes a capture timer value setting part 234 for setting the timer value of the capture timer part 250.

The capture timer value setting part 234 sets the timer value of the capture timer part 250 to a predetermined offset time [ms] when the vehicle 2 is started, and specifically, when the mode of the power switch of the vehicle 2 is switched from the OFF mode to the ACC mode or the ON mode. Specifically, the capture timer value setting part 234A of the control device 20A sets the timer value of the capture timer part 250A to the first offset time T1 [ms]. The capture timer value setting part 234B of the control device 20B sets the timer value of the capture timer part 250B to a second offset time T2 [ms]. In the present embodiment, the second offset time T2 is a value greater than the first offset time T1.

Even when the imaging system 1 is configured in this manner, as described above with reference to FIG. 3 of the first embodiment, infrared imaging can be performed by the infrared camera module 100, which is the master device, at time t1, and thereafter, at timing t2, which is delayed from time t1 by the predetermined offset time T1 (timer value), infrared imaging can be performed by the infrared camera module 200A, which is a slave device daisy-chain connected with the infrared camera module 100. At timing t3, which is delayed from time t1 by the predetermined offset time T2 (timer value), infrared imaging can then be performed by the infrared camera module 200B, which is a slave device daisy-chain connected with the infrared camera module 100.

The imaging system 1 according to the present embodiment described above includes an infrared camera module 100 (first camera module) for performing infrared imaging by irradiating a predetermined first range with infrared light, a control device 10 (first control device) for controlling the infrared camera module 100, and an infrared camera module 200A (second camera module) which is daisy-chain connected with the infrared camera module 100 via a communication line 3, and which is for performing infrared imaging by irradiating a predetermined second range, at least a part of which overlaps the first range, with infrared light. The infrared camera module 100 is configured to start infrared imaging in response to a capture instruction signal (infrared imaging instruction) from the control device 10, and to transmit the capture instruction signal to the infrared camera module 200A via the communication line 3. The infrared camera module 200A is configured to start infrared imaging after a predetermined offset time T1 has elapsed after receiving the capture instruction signal from the infrared camera module 100.

Furthermore, the imaging system 1 according to the present embodiment further includes an infrared camera module 200B (third camera module) which is daisy-chain connected with the infrared camera module 200A (second camera module) via a communication line 4 (second communication line), and which is for performing infrared imaging by irradiating a predetermined third range, at least a part of which overlaps the first range and the second range, with infrared light. The infrared camera module 200A is configured to transmit an infrared imaging instruction to the infrared camera module 200B via the communication line 4 in response to an infrared imaging instruction from the infrared camera module 100. The infrared camera module 200B is configured to start infrared imaging after a predetermined offset time T2 has elapsed since receiving the capture instruction signal from the infrared camera module 200A.

By issuing an infrared imaging instruction from the infrared camera module 100, which is the master device, to the infrared camera modules 200A, 200B, which are slave devices in this manner, the capture timing of each of the infrared camera modules 100, 200A, 200B can be controlled without performing time synchronization between each of the control devices 10, 20A, 20B, whereby it is possible to prevent the capture timing of each of the infrared camera modules 100, 200A, 200B from deviating from the appropriate timing.

Though the embodiments of the present disclosure have been described above, the above embodiments merely demonstrate some of the application examples of the present disclosure, and are not intended to limit the technical scope of the present disclosure to the specific configurations of the above embodiments.

For example, though examples in which three infrared camera modules are used in each of the above embodiments have been illustrated and explained, naturally, the number of infrared camera modules may be two or may be four or more.

Furthermore, in the embodiments described above, the computer program executed in the control devices 10, 20 may be provided in a form recorded on a computer-readable portable recording medium such as a semiconductor memory, a magnetic recording medium, or an optical recording medium, or may be provided as a computer program product.

1. An imaging system, comprising:
a first camera module for performing infrared imaging by irradiating a predetermined first range with infrared light;
a first control device for controlling the first camera module; and
a second camera module which is connected to the first camera module via a communication line, and which is for performing infrared imaging by irradiating a predetermined second range, at least a part of which overlaps the first range, with infrared light, wherein
the first camera module:
in response to an infrared imaging instruction from the first control device, starts infrared imaging and transmits an infrared imaging instruction to the second camera module via the communication line after a predetermined offset time has elapsed from start of the infrared imaging, and
the second camera module:
in response to the infrared imaging instruction from the first camera module, starts infrared imaging.

2. The imaging system according to claim 1, wherein a first infrared image generated by infrared imaging of the first camera module is an infrared image having a higher acquisition priority than a second infrared image generated by infrared imaging of the second camera module.

3. The imaging system according to claim 2, wherein the first camera module and the second camera module are mounted on a vehicle,
the first infrared image is used for performing safe driving support of the vehicle, and
the second infrared image is used for a separate purpose different than the safe driving support of the vehicle.

4. The imaging system according to claim 1, wherein the first camera module and the second camera module are mounted on a vehicle, and
infrared imaging of the first camera module and the second camera module are suspended when a mode of a power switch of the vehicle is changed to an OFF mode.

5. The imaging system according to claim 1, wherein the offset time:
is set to a time such that a timing when infrared light is emitted from the second camera module for infrared imaging is after a timing when an exposure period during which reflected light of infrared light emitted from the first camera module for infrared imaging is received by the first camera module has ended.

6. The imaging system according to claim 1, wherein the offset time is set by the first control device.

7. The imaging system according to claim 1, wherein the first camera module and the second camera module are daisy-chain connected by the communication line.

8. The imaging system according to claim 1, further comprising a third camera module which is connected to the second camera module via a second communication line, and which is for performing infrared imaging by irradiating a predetermined third range, at least a part of which overlaps the first range and the second range, with infrared light, wherein
the second camera module:
in response to an infrared imaging instruction from the first camera module, starts infrared imaging and transmits an infrared imaging instruction to the third camera module via the second communication line after a predetermined second offset time has elapsed from start of the infrared imaging, and
the third camera module:
in response to the infrared imaging instruction from the second camera module, starts infrared imaging.

9. The imaging system according to claim 8, wherein the second offset time:
is set to a time such that a timing when infrared light is emitted from the third camera module for infrared imaging is after a timing when an exposure period during which reflected light of infrared light emitted from the second camera module for infrared imaging is received by the second camera module has ended.

10. The imaging system according to claim 8, further comprising a second control device for controlling the second camera module, wherein
the second offset time is set by the second control device.

11. The imaging system according to claim 8, wherein the first camera module and the second camera module are daisy-chain connected by the communication line, and the second camera module and the third camera module are daisy-chain connected by the second communication line.

12. An imaging system, comprising:
a first camera module for performing infrared imaging by irradiating a predetermined first range with infrared light,
a first control device for controlling the first camera module, and
a second camera module which is connected to the first camera module via a communication line, and which is for performing infrared imaging by irradiating a predetermined second range, at least a part of which overlaps the first range, with infrared light, wherein
the first camera module:
in response to an infrared imaging instruction from the first control device, starts infrared imaging and transmits an infrared imaging instruction to the second camera module via the communication line, and
the second camera module:
starts infrared imaging after a predetermined offset time has elapsed since receiving the infrared imaging instruction from the first camera module.

13. The imaging system according to claim 12, further comprising a third camera module which is connected to the second camera module via a second communication line, and which is for performing infrared imaging by irradiating a predetermined third range, at least a part of which overlaps the first range and the second range, with infrared light, wherein
the second camera module:
in response to an infrared imaging instruction from the first camera module, transmits an infrared imaging instruction to the third camera module via the second communication line, and
the third camera module:
starts infrared imaging after a predetermined second offset time has elapsed since receiving the infrared imaging instruction from the second camera module.

14. The imaging system according to claim 13, further comprising:
a second control device for controlling the second camera module, and
a third control device for controlling the third camera module, wherein
the offset time is set by the second control device, and
the second offset time is set by the third control device.
